(19) United States
(12) Patent Application Publication
(10) Pub. No.: US 2012/0148161 A1
(43) Pub. Date: Jun. 14, 2012

(54) APPARATUS FOR CONTROLLING FACIAL EXPRESSION OF VIRTUAL HUMAN USING HETEROGENEOUS DATA AND METHOD THEREOF

(75) Inventor: Jae Hwan KIM, Daejeon (KR)

(73) Assignee: ELECTRONICS AND TELECOMMUNICATIONS RESEARCH INSTITUTE, Daejeon (KR)

(21) Appl. No.: 13/213,807

(22) Filed: Aug. 19, 2011

(30) Foreign Application Priority Data
Dec. 9, 2010 (KR) 10-2010-0125844

(51) Int. Cl. G06K 9/46

(52) U.S. Cl. 382/195

(57) ABSTRACT

Disclosed are an apparatus for controlling facial expression of a virtual human using heterogeneous information and a method using the same. The apparatus for controlling expression of a virtual human using heterogeneous information includes: an extraction module extracting feature data from input image data and sentence or voice data; a DB construction module classifying the extracted feature data into a set of emotional expressions and a emotional expression category by using a set of pre-constructed index data on heterogeneous data; a recognition module transferring the classified emotional expression category; and a viewing module viewing the images and the sentence or voice of the virtual human according to the emotional expression category. By this configuration, the exemplary embodiment of the present invention can delicately express emotion of a virtual human and increase recognition for emotional classification accordingly.

### CROSS-REFERENCE TO RELATED APPLICATIONS

This application claims priority to and the benefit of Korean Patent Application No. 10-2010-0125844 filed in the Korean Intellectual Property Office on Dec. 9, 2010, the entire contents of which are incorporated herein by reference.

### TECHNICAL FIELD

The present invention relates to an apparatus and a method controlling facial expression of a virtual human, and more particularly, to an apparatus for controlling facial expression of a virtual human using heterogeneous data capable of delicately controlling facial expression of a virtual human by using DBs grouped through a correlation graph of feature data groups regarding image data and sentence or voice data while using the image data and the sentence or voice data having limited expression, and a method using the same.

### BACKGROUND

Recently, an appearance of a virtual human appearing coinciding with the development of computer graphics has been frequently used in various media such as movie, TV, game, and so on. The virtual human is a character like a person. An example of concerns of the virtual human may include appearance, realistic operations, nature facial expression, or the like. In particular, facial features or expression play an important role of recreating a virtual character as a personal character.

Persons react very sensitively to the facial expression of others, such that it is difficult to control the facial expression of the virtual human. Various methods have been researched long before in order to produce a face model of a virtual human and allocate the expression to the model.

An example of a face expressing technology based on the existing face/facial expression recognition may largely include a technology of constructing a facial expression DB, a technology of using a constructed DB and various supervised learning methodologies, and an image morphing technology for naturally synthesizing with specific images after recognition.

However, most of the technologies tend to perform inputs limited to homogeneous data, such images, documents, or the like, and perform classification in a predefined category rather than creating new images through the recognition of given images.

Further, a template model matching methodology for object appearance within input images, which is referred to as an active appearance model (AAM), has been mainly researched as an application fields for tracking an area and recognizing face expression, but involves many unsolved problems, such as previous information on an initial facial model, initialization of model parameters, many calculations, or the like.

### SUMMARY

The present invention has been made in an effort to provide an apparatus for controlling facial expression of a virtual human using heterogeneous data capable of delicately controlling facial expression of a virtual human by using DBs grouped through a correlation graph of feature data groups regarding image data and sentence or voice data while using the image data and the sentence or voice data having limited expression, and a method using the same.

An exemplary embodiment of the present invention provides an apparatus for controlling facial expression of a virtual human using heterogeneous information, including: an extraction module extracting feature data from input image data and sentence or voice data; a DB construction module classifying the extracted feature data into a set of emotional expressions and a emotional expression category by using a set of pre-constructed index data on heterogeneous data; a recognition module transferring the classified emotional expression category; and a viewing module viewing the images and the sentence or voice of the virtual human according to the emotional expression category.

The DB construction module may measure a distance between the extracted feature data and data in the DB construction module referenced for recognition and when the proximity structure is maintained according to the distance measurement results, classify the feature data into the set of emotional expression or the emotional expression category by using the set of the pre-constructed index data.

The DB construction module may measure a distance by using a commute-time metric function.

The DB construction module may construct the set of index data by performing co-clustering or bipartite graph partitioning on the sets of pre-defined feature images and feature words.

The DB construction module may group the sets of predefined feature images and feature words having a similar nature into a single group by using the co-clustering or the bipartite graph partitioning to construct the set of index data.

The DB construction module may generate the feature data for images from words based on the emotional expression category and generate the feature data for words from images.

The viewing module may perform expression wraphing for naturally synthesizing images and may not perform the wraphing on the entire images but perform the expression wraphing using local wraphing.

The viewing module may include a self-evaluation module that receives the active reaction of the user for the emotional expression of the virtual human and feedbacks the input reaction information to the DB construction module.

Another exemplary embodiment of the present invention provides a method for controlling facial expression of a virtual human using heterogeneous information, including: (a) extracting feature data from input image data and sentence or voice data; (b) classifying the extracted feature data into a set of emotional expressions and a emotional expression category by using a set of pre-constructed index data on heterogeneous data; and (c) viewing images and sentence or voice of the virtual human according to the classified emotional expression category.

The classifying may measure a distance between the extracted feature data and data in the DB construction module referenced for recognition and when the proximity structure is maintained according to the distance measurement results, classify the feature data into the set of emotional expression or the emotional expression category by using the set of the pre-constructed index data.

The classifying may measure a distance by using a commute-time metric function.

The classifying may construct the set of index data by performing co-clustering or bipartite graph partitioning on the sets of pre-defined feature images and feature words.

The classifying may group the sets of predefined feature images and feature words having a similar nature into a single group by using the co-clustering or the bipartite graph partitioning to construct the set of index data.

The classifying may generate the feature data for images from words based on the emotional expression category and generates the feature data for words from images.

The viewing may perform expression wraphing for naturally synthesizing images and may not perform the wraphing on the entire images but perform the expression wraphing using local wraphing.

As set forth above, the exemplary embodiment of the present invention can delicately express emotion by controlling the facial expression of the virtual human by using the DBs grouped through the correlation graph of the feature data groups regarding the image data and the sentence or voice data while using the image data and the sentence or voice data having limited expression.

Further, the exemplary embodiment of the present invention can delicately express emotion by using the image data and the sentence or voice data, thereby making it possible to increase the recognition for emotional classification.

### BRIEF DESCRIPTION OF THE DRAWINGS

FIG. 1 is an exemplified diagram showing an apparatus for controlling facial expression of a virtual human according to an exemplary embodiment of the present invention;

FIG. 2 is an exemplified diagram for explaining data embedding according to an exemplary embodiment of the present invention;

FIG. 3 is an exemplified diagram showing a set of feature images and feature words;

FIG. 4 is an exemplified diagram showing a simultaneous grouping of feature images and feature words; and

FIG. 5 is an exemplified diagram showing a method for controlling facial expression of a virtual human according to another exemplary embodiment of the present invention.

### DETAILED DESCRIPTION

Hereinafter, exemplary embodiments of the present invention will be described in detail with reference to the accompanying drawings. In this description, when any one element is connected to another element, the corresponding element may be connected directly to another element or with a third element interposed therebetween. First of all, it is to be noted that in giving reference numerals to elements of each drawing, like reference numerals refer to like elements even though like elements are shown in different drawings. The components and operations of the present invention illustrated in the drawings and described with reference to the drawings are described as at least one exemplary embodiment and the spirit and the core components and operation of the present invention are not limited thereto.

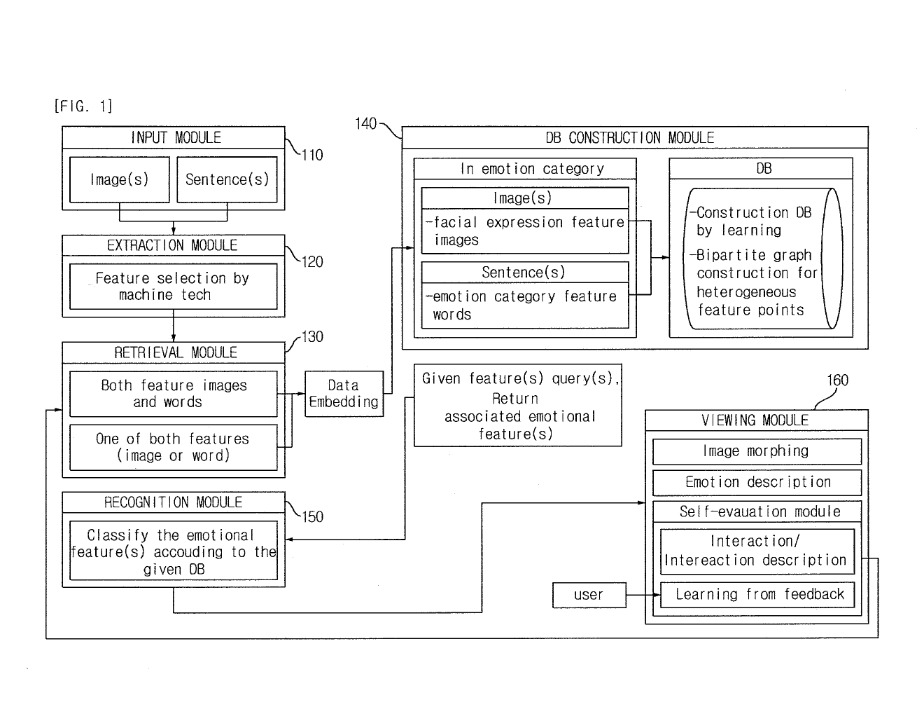

Hereinafter, an apparatus for controlling facial expression of a virtual human using heterogeneous information and a method using the same according to the exemplary embodiment of the present invention will be described with reference to FIGS. 1 to 5. Portions necessary to understand operations and effects according to the present invention will be mainly described in detail below.

The exemplary embodiment of the present invention proposes a scheme capable of delicately expressing facial expression of a virtual human by controlling the facial expression of the virtual human by using the DBs grouped through the correlation graph of the feature data groups regarding the image data and the sentence or voice data while using the image data and the sentence or voice data having limited expression. That is, the exemplary embodiment of the present invention is to supplement vague information from image data with characters or voice data or supplement vague information from character or voice data with image data, by using the image data and the character or voice data.

FIG. 1 is an exemplified diagram showing an apparatus for controlling facial expression of a virtual human according to an exemplary embodiment of the present invention.

As shown in FIG. 1, an apparatus for controlling facial expression of a virtual human according to the exemplary embodiment of the present invention may be configured to include an input module 110, an extraction module 120, a retrieval module 130, a DB construction module 140, a recognition module 150, a viewing module 160, a self-evaluation module 160a, or the like.

The input module 110 receives image data and character or voice data from a user and the extraction module 120 extracts feature data from the input image data and the sentence or voice data. In this case, the feature data implies data having unchanged information under any conditions.

For example, the extraction module 110 extracts positional coordinate values such as an eyebrow shape, a mouth shape, or the like, from image data as feature data capable of recognizing facial expression or specific words from sentence or voice data, or the like.

The retrieval module 130 requests the classification of emotion expression for the extracted feature data to the DB construction module 140.

The DB construction module 140 measures a distance between data given as a query and data in the DB referenced for recognition and embeds data by using a measurement function capable of maintaining a proximity structure between points in a metric space and a non-metric space.

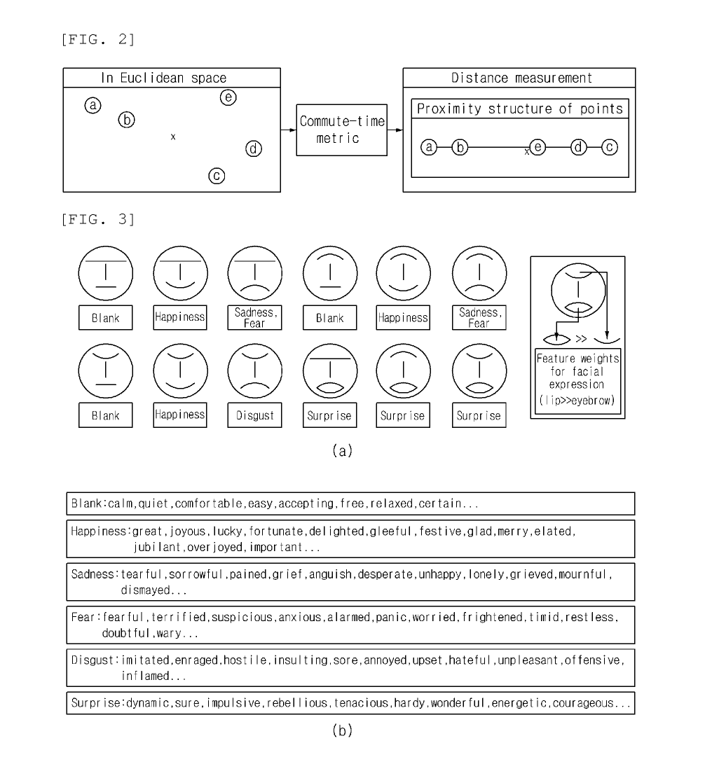

FIG. 2 is an exemplified diagram for explaining data embedding according to an exemplary embodiment of the present invention.

As shown in FIG. 2, the data embedding according to the exemplary embodiment of the present invention uses methods of using several kernel functions as an efficient method of reducing data dimension. These methods maintain the proximity structure only in the specific space and do not build the relationship in other spaces.

Therefore, the exemplary embodiment of the present invention uses a general embedding kernel function maintaining a proximity structure both in the metric space and the non-metric space. In particular, the exemplary embodiment of the present invention uses a commute-time metric function as a distance measurement function, thereby making it possible to solve the problem that the embedding coordinates is unstable due to the surrounding noise data.

The DB construction module 140 classifies the feature data into an emotional expression set or an emotional expression category by using the set of the pre-constructed index data when the proximity structure is maintained according to the distance measurement results.

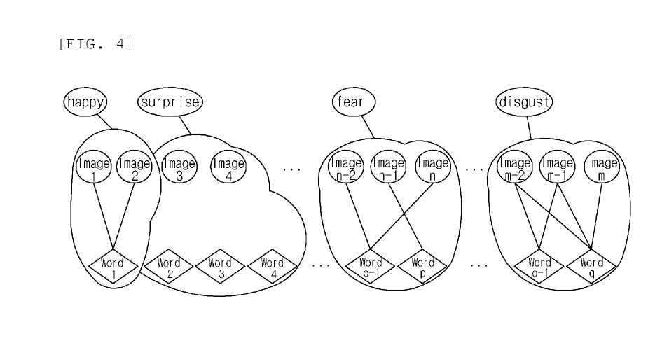

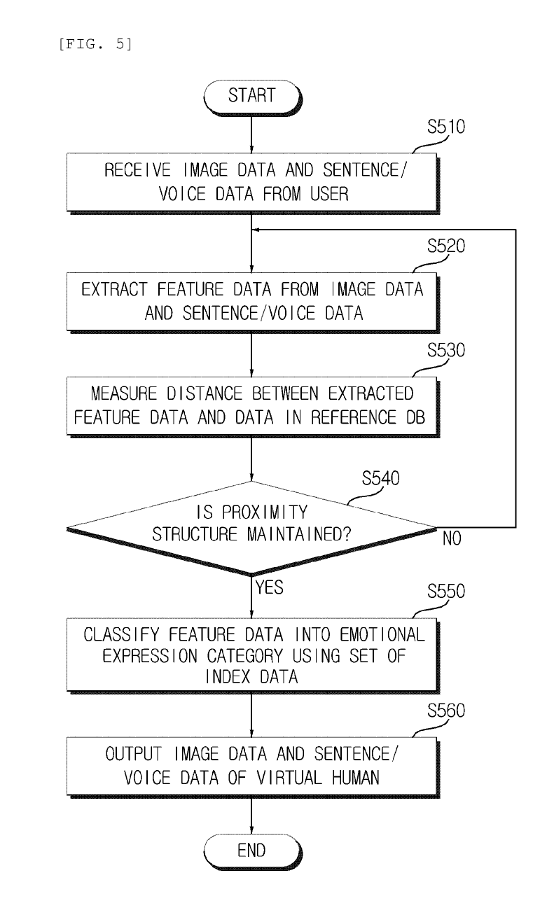

In this case, the DB construction module 140 constructs the set of the index data to be compared for recognizing any data. The DB construction module 140 structurally accumulates and constructs the relationship between the feature images and the specific words mainly used for the expression description in the facial expression category for the image data and the sentence data input from the user, which will be described with reference to FIGS. 3 to 4.

First, the set of the image data and sentence data is defined according to various emotional expressions. FIG. 3 is an exemplified diagram showing a set of feature images and feature words according to the exemplary embodiment of the present invention.

As shown in FIG. 3, the DB construction module 140 according to the exemplary embodiment of the present invention defines the emotional expression as 6 expressions such as blank, happiness, sadness, surprise, fear, disgust, or the like.

For example, in FIG. 3A, the set of various feature images for the facial expression describing the emotional expressions defined by the above-mentioned 6 expressions, that is, various facial expressions for single emotional expression are defined. In FIG. 3B, various feature words for words describing the emotional expressions defined by the above-mentioned 6 expression, that is, a set of various words for a single emotional expression is defined.

The sets of the feature images and the feature words defined as described above are grouped by using co-clustering or a bipartite graph partitioning.

In this case, the co-clustering is classified into supervised learning, unsupervised learning, and semi-supervised learning. Among others, the unsupervised learning simultaneously groups the given data sets adjacent to each other or having a similar nature according to the measurement standard or model of any similarity or proximity defined by a user without previous information on data, but mainly groups the homogeneous data.

Meanwhile, the bipartite graph partitioning simultaneously groups the heterogeneous data.

FIG. 4 is an exemplified diagram showing a simultaneously grouping of feature images and feature words.

As shown in FIG. 4, the DB construction module 140 according to the exemplary embodiment of the present invention constructs the index data DB by performing the co-clustering or the bipartite graph partitioning on the sets of the feature images and feature words defined in FIG. 3.

That is, the DB construction module 140 constructs the meaning relationship graph severing as a connection loop for the feature images and the feature words, that is, the similarity connection graph for the heterogeneous data. For example, in FIG. 4, when expressing the emotion such as happiness, image 1 is connected with word 1 and image 2 is connected with word 1, such that different images may be connected with each other even in the case of the same words in the same emotional expression or different words may be connected with each other even in the same image.

In addition, when the DB construction module 140 includes additional data, it can learn and reflect two heterogeneous data through only one of the feature images and the feature words. That is, the DB construction module 140 can generate the feature data for images from words or the feature data for words from images.

By constructing the DB for the heterogeneous data as described above, the exemplary embodiment of the present invention can secure high-precision recognition through small calculations, that is, low-dimensional data by using the complementary relationship for the above-mentioned heterogeneous feature data at the time of the emotional classification for any input data.

The recognition module 150 receives the emotional expression category in which the feature data are classified and the viewing module 160 outputs the image data and the sentence or voice data of the virtual human according to the emotional expression category.

The viewing module 160 performs facial expression wraphing for naturally synthesizing images. The viewing module 160 does not perform the wraphing on the entire images but performs the expression wraphing using local wraphing. That is, the spatial change of images is performed through the correspondence matching between the original images and the object images for specific parts such as the mouth, nose, and eye of a face.

In this case, the viewing module 160 may include a self-evaluation module 160a. The self-evaluation module 160a receives the active reaction of the user for the output emotional expression of the virtual human. The reaction information from the user is again feedback to the retrieval module.

This is needed to increase the interaction expression and the self-evaluation performance through camera recognition. In other words, the interaction/reaction technology between the user and the virtual human and between the virtual humans perform to track and recognize feature points for the eye/mouth/expression of the user by using the camera referring the given DB. The natural interaction and reaction is expressed through the user feedback learning for the camera-based image recognition process and the recognition results. In addition, since the situations and expression information are given between the virtual humans, the natural interaction/reaction expression such as the interaction expression method with the user can be described.

FIG. 5 is an exemplified diagram showing a method for controlling facial expression of a virtual human according to another exemplary embodiment of the present invention.

As shown in FIG. 5, the apparatus for controlling facial expression of a virtual human according to the exemplary embodiment of the present invention receives the image data and the character or voice data from the user (S510) and extracts the feature data from the input image data and sentence or voice data (S520).

Next, the apparatus for controlling facial expression of a virtual human measures a distance between the extracted feature data and data in the DB referenced for recognition (S530) and confirms whether the proximity structure between the feature data according to the distance measurement results is maintained, that is, whether the similarity is maintained within the predetermined range (S540).

When the proximity structure is maintained, the apparatus for controlling facial expression of a virtual human classifies the feature data into the set of emotional expressions or the emotional expression category by using the set of the pre-constructed index data (S550). On the other hand, the apparatus for controlling facial expression of a virtual human again extracts the feature data when the proximity structure is not maintained.

Next, the apparatus for controlling facial expression of a virtual human outputs the image data and sentence or voice data of the virtual human according to the classified emotional expression category to control the expression of the virtual human when the emotional expression category is classified (S560).

As set forth above, the exemplary embodiment of the present invention controls the facial expression of the virtual human by using the DBs grouped through the correlation graph of the feature data groups regarding the image data and the sentence or voice data while using the image data and the sentence or voice data having limited expression, thereby making it possible to delicately express the expression of the virtual human and increase the recognition for the emotional classification.

As described above, the exemplary embodiments have been described and illustrated in the drawings and the specification. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. An apparatus for controlling facial expression of a virtual human using heterogeneous information, comprising:
an extraction module extracting feature data from input image data and sentence or voice data;
a DB construction module classifying the extracted feature data into a set of emotional expressions and a emotional expression category by using a set of pre-constructed index data on heterogeneous data;
a recognition module transferring the classified emotional expression category; and
a viewing module viewing the images and the sentence or voice of the virtual human according to the emotional expression category.

2. The apparatus of claim 1, wherein the DB construction module measures a distance between the extracted feature data and data in the DB construction module referenced for recognition and when the proximity structure is maintained according to the distance measurement results, classifies the feature data into the set of emotional expression or the emotional expression category by using the set of the pre-constructed index data.

3. The apparatus of claim 2, wherein the DB construction module measures a distance by using a commute-time metric function.

4. The apparatus of claim 1, wherein the DB construction module constructs the set of index data by performing co-clustering or bipartite graph partitioning on the sets of pre-defined feature images and feature words.

5. The apparatus of claim 4, wherein the DB construction module groups the sets of predefined feature images and feature words having a similar nature into a single group by using the co-clustering or the bipartite graph partitioning to construct the set of index data.

6. The apparatus of claim 1, wherein the DB construction module generates the feature data for images from words based on the emotional expression category and generates the feature data for words from images.

7. The apparatus of claim 1, wherein the viewing module performs expression wrapping for naturally synthesizing images and does not perform the wraphing on the entire images but performs the expression wraphing using local wraphing.

8. The apparatus of claim 1, wherein the viewing module includes a self-evaluation module that receives the active reaction of the user for the emotional expression of the virtual human and feedbacks the input reaction information to the DB construction module.

9. A method for controlling facial expression of a virtual human using heterogeneous information, comprising:
(a) extracting feature data from input image data and sentence or voice data;
(b) classifying the extracted feature data into a set of emotional expressions and a emotional expression category by using a set of pre-constructed index data on heterogeneous data; and
(c) viewing images and sentence or voice of the virtual human according to the classified emotional expression category.

10. The method of claim 9, wherein the classifying measures a distance between the extracted feature data and data in the DB construction module referenced for recognition and when the proximity structure is maintained according to the distance measurement results, classifies the feature data into the set of emotional expression or the emotional expression category by using the set of the pre-constructed index data.

11. The method of claim 10, wherein the classifying measures a distance by using a commute-time metric function.

12. The method of claim 9, wherein the classifying constructs the set of index data by performing co-clustering or bipartite graph partitioning on the sets of pre-defined feature images and feature words.

13. The method of claim 12, wherein the classifying groups the sets of predefined feature images and feature words having a similar nature into a single group by using the co-clustering or the bipartite graph partitioning to construct the set of index data.

14. The method of claim 9, wherein the classifying generates the feature data for images from words based on the emotional expression category and generates the feature data for words from images.

15. The method of claim 9, wherein the viewing performs expression wraphing for naturally synthesizing images and does not perform the wraphing on the entire images but performs the expression wraphing using local wraphing.
